(19) United States
(12) Patent Application Publication
(10) Pub. No.: US 2015/0006359 A1
(43) Pub. Date: Jan. 1, 2015

(54) NETWORK-BASED SYSTEM AND METHOD FOR IMPLEMENTING USER-SPECIFIED TRANSACTIONS FOR TRANSFERRING DIGITAL CONTENT ITEMS AMONGST USERS

(71) Applicant: Kobo Inc., Toronto (CA)

(72) Inventors: Robert MacArthur, Milton (CA); James Wu, Newmarket (CA)

(21) Appl. No.: 13/955,858

(22) Filed: Jul. 31, 2013

Related U.S. Application Data
(63) Continuation-in-part of application No. 13/930,603, filed on Jun. 28, 2013.

(51) Int. Cl. G06Q 50/18; G06Q 20/12

(52) U.S. Cl. CPC G06Q 50/184; G06Q 20/123
USPC 705/39; 705/310

(57) ABSTRACT

A user is provided an interface to specify input corresponding to a set of requested terms for soliciting a transfer of a particular digital content item. The set of requested terms are determined from the input. A determination is also made as to whether the user has a right to transfer the particular digital content item. An offer is published for the user that includes the set of requested terms.

### RELATED APPLICATIONS

This application is a continuation-in-part of U.S. patent application Ser. No. 13/930,603, filed Jun. 28, 2013; the aforementioned priority application being hereby incorporated by reference in its entirety.

### TECHNICAL FIELD

Embodiments described herein relate to a network-based method for implementing user-specified transactions for transferring digital content items amongst users.

### BACKGROUND

Digital content has become pervasive, in that consumers can now purchase various types of digital content items from numerous network or online sources. The distribution of digital content often includes programmatic controls to preclude users from distributing the content themselves.

### BRIEF DESCRIPTION OF THE DRAWINGS

FIG. 1 illustrates a system for enabling a user to transfer a right of possession to a digital content item to another user in accordance with one or more user-specified transaction parameters, according to an embodiment.

FIG. 2 illustrates an example of a mobile computing device in accordance with examples described herein.

FIG. 3 illustrates an example transfer manager operating as part of a network service, according to an embodiment.

FIG. 4 illustrates an example method for processing a submission from a user wishing to publish an offer for transferring an e-book from the user's library, according to an embodiment.

FIG. 5A illustrates an example method for publishing an offer for transferring an e-book with user specified parameters, according to an embodiment.

FIG. 5B illustrates an example method for implementing terms of an offer upon the offer being accepted, according to an embodiment.

FIG. 6 illustrates an example of a transaction interface for enabling a user to specify transaction parameters for generating an offer to transfer an e-book to another user, according to an embodiment.

### DETAILED DESCRIPTION

Examples described herein include a network service that enables user-specified transactions for transferring digital content items amongst users.

According to some examples, a network service is provided that enables users to specify parameters for the transfer of digital content items. The network service is able to discover the specified parameters, and implement a transfer of a digital content item in accordance with terms that correspond to the specified parameters.

In an embodiment, a user is provided an interface to specify input corresponding to a set of requested terms for soliciting a transfer of a particular digital content item. The set of requested terms are determined from the input. A determination is also made as to whether the user has a right to transfer the particular digital content item. An offer is published for the user that includes the set of requested terms.

Embodiments described herein provide a computing system and/or network environment in which users can transfer (or initiate transfer of) digital content items to other users in accordance with a variety of transaction parameters that are specified by the user. Among other examples, the user can specify a type of transaction (e.g., sale, load or exchange), price or price range, and schedule for when the transaction can be completed.

As used herein, a “digital content item” can be provided in the form of one or more files that include content (e.g., content portion). Digital content items can also include various kinds of metadata (e.g., metadata portion), including metadata for providing a visual representation of the digital content item. With respect to examples described herein, digital content items can include, for example, audio playback content items (e.g., songs), video playback content items (e.g., television shows, movies, and music videos), e-books, electronic magazines, digital comic books and multimedia games. While numerous embodiments described herein make reference to e-books, it should be appreciated that e-books are just one example of a digital content item for use with examples as described, and embodiments described herein are applicable to digital content items other than e-books, such as songs (or albums), videos (e.g., movies, television shows, video clips, music videos, etc.), or other works that can be embodied in a digital medium.

“E-books” are a form of an electronic publication that can be viewed on computing devices with suitable functionality. Multi-function devices, such as cellular-telephony or messaging devices, can utilize specialized applications (e.g., e-reader apps) to view e-books. Still further, some devices (sometimes labeled as “e-readers”) can be centric towards content viewing, and e-book viewing in particular.

As used herein, a transfer in the right of possession is intended to mean that the right of a given user to enjoy or otherwise consume a content portion of a digital content item is transferable. A transfer in the right of ownership to a particular digital content item can constitute a transfer in the right of possession. However, many examples described herein recognize that consumers do not often purchase true ownership to individual content items, as various digital rights management rules and laws preclude the user from truly owning a purchased copy of a digital content item. For simplicity, some examples may be described in the context of purchasing a digital content item (such as an e-book), and such example should be read in context in which what is actually purchased is a right of possession that permits the user to enjoy or otherwise consume (e.g. read, playback, etc.) a digital content item. When reference is made to a “transferred” digital content item, it is intended to mean that a right to possession of at least a content portion of the digital content item has been transferred. Terms such as “resell” are intended as an example for the transfer in the right of possession to at least the content portion of a digital content item.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

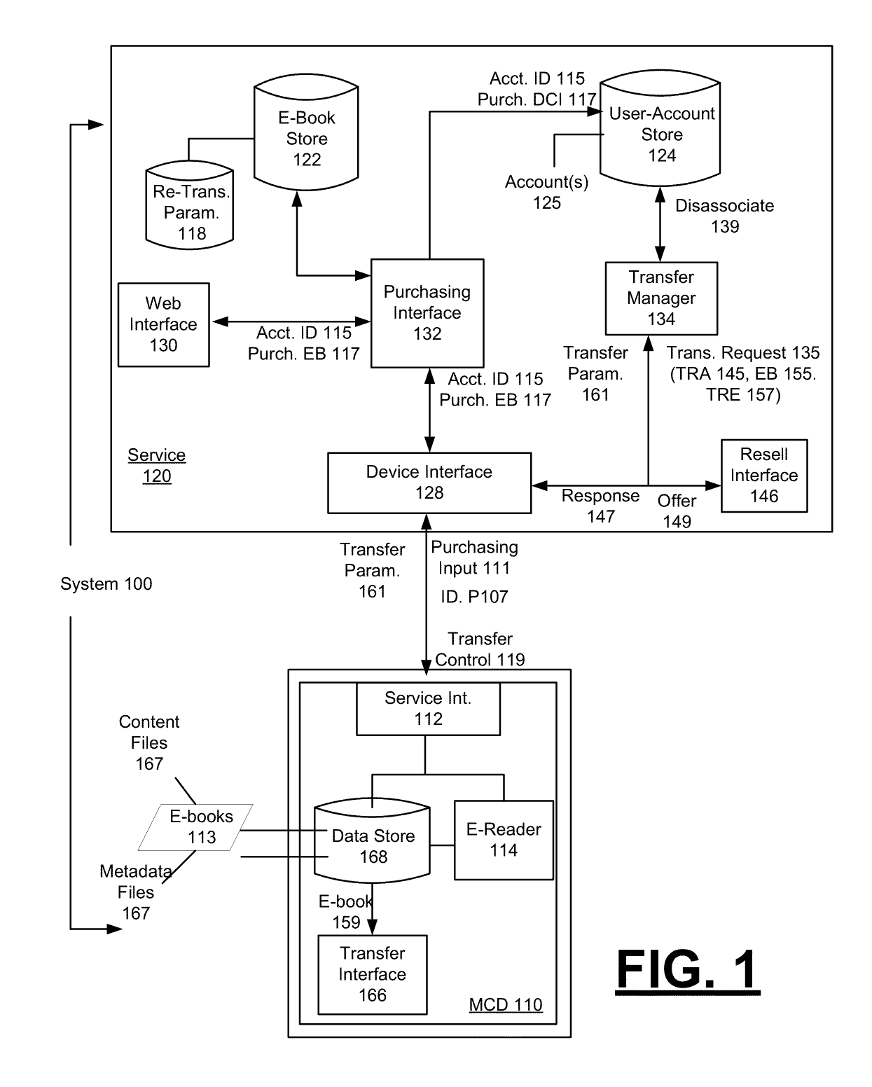

FIG. 1 illustrates a system for enabling a user to transfer a right of possession to a digital content item to another user in accordance with one or more user-specified transaction parameters, according to an embodiment. In an example of FIG. 1, system 100 includes a mobile computing device 110 and a network service 120. The network service 120 can include multiple servers and other computing resources that provide various e-book services, including services in which e-books are sold, re-sold, borrowed, shared, downloaded and/or stored. The mobile computing device 110 can correspond to any computing device on which an e-book can be rendered and consumed. For example, the mobile computing device 110 can correspond to a tablet, telephony/messaging device (e.g., smart phone) or portable computing device. The mobile computing device 110 can run an e-reader component 114 that links the device to the network service 120 and enables e-books provided through the service to be viewed and consumed.

In some implementations, the mobile computing device 110 is equipped with hardware and software to optimize reading electronic content, including e-books. For example, the mobile computing device 110 can have a tablet like form factor, although variations are possible. In some cases, the mobile computing device 110 can also have an electronic paper type display (e.g., E-ink display).

The network service 120 can include a device interface 128, which communicates with individual devices that access the service. Among other resources, the network service 120 can include a network e-book store 122 and a user account store 124. The user account store 124 can associate computing device 110 with a user and an account 125. The account 125 can also be associated with one or more e-books, which can be stored in the network e-book store 122. As described further, the user account store 124 can retain metadata for individual accounts 125 to identify e-books that have been purchased or made available for consumption for a given account. As described with many examples, the metadata can include supplemental transaction information, such as whether the user has purchased or otherwise acquired the right to re-transfer an e-book.

The mobile computing device 110 may be associated with the user account 125, and multiple devices may be associated with the same account. As described in greater detail below, the mobile computing device 110 can store e-books that are purchased or otherwise made available to the user of the mobile computing device 110. The mobile computing device 110 can also locally store other metadata and account information, such as metadata that identifies which e-books the user has the right to re-transfer (e.g., re-sell e-book).

In some embodiments, the network service 120 communicates with an application or other functionality provided on the mobile computing device 110 in order to enable a user to conduct purchasing activity for digital content items made available from or through the network service 120. Specific examples of purchasing activity that can be enabled for mobile computing device 110 include the ability of the user to purchase or otherwise download digital content items, such as e-books, as well as the ability of the user to re-sell or transfer rights to such digital content items to other users. Still further, other types of activities that can be enabled for mobile computing device 110 include an ability to share an experience with the digital content item with other like-minded users.

According to some embodiments, network service 120 can include the web interface 130, a purchasing interface 132, and a transfer manager 134. The purchasing interface 132 can provide functionality to enable users to access and utilize the network e-book store 122. The purchasing interface 132 can be provided as, for example, an online store which interfaces or otherwise uses the network e-book store 122. By way of example, the purchasing interface 132 enables a user to perform various kinds of purchasing activity, including activity to search for e-books, read reviews, make purchases for e-books, and purchase or otherwise acquire right to re-sell purchased e-book. For example, the user can purchase an e-book by making payment and then downloading a digital copy of the e-book to a device associated with the user's account. The purchasing interface 132 can include functionality for linking a user account so as to enable payment, as well as to link a purchase or otherwise downloaded digital content item with the user's account 125. In some examples, multiple devices may be associated with the user's account 125, and the purchased digital content item can be downloaded and/or made available to each device that is associated with the particular user account.

In implementation, mobile computing device 110 can be operated to communicate with device interface 128 to access the purchasing interface 132. For example, the user can operate the mobile computing device 110 to access the online bookstore for an e-reader, or alternatively, for a tablet on which an e-reader application is provided. In one implementation, the user can operate an application on the mobile computing device 110 to specify to network service 120 an identifier 107 that can be used to determine a user's account. For example, the application running on the mobile computing device 110 can be associated with a login that is shared by the user's account, or alternatively the network service 120 can use the identifier 107 transmitted by the mobile computing device 110 to link to the user's account (e.g., link to account identifier 115).

In variations, the user can access the purchasing interface 132 through the web interface 130. For example, the user can access a website corresponding to network service 120, and then make a purchase of a particular digital content item using account identifier 115. Thus, according to various implementations, a user can perform different kinds of purchasing activity through, for example, either the mobile computing device 110 (e.g., application on the mobile computing device) or web browser (to access website).

In one example, a purchasing input 111 can be generated from the mobile computing device 110 in response to use input. On the network service 120, the purchasing input 111 can be communicated via the device interface 128 to the purchasing interface 132. The purchasing input 111 can be directed towards a purchasing activity, such as a search for an e-book, or a request to purchase an e-book, etc. Alternatively, the purchasing input 111 can originate from a user accessing a corresponding website and using a web browser, and communicated to the network service 120 using a web interface 130 (e.g., web page). The purchasing input 111 can be linked to the account identifier 115 of the user, which can be associated with user information stored in the user account store 124. The user information can include transaction information such as the user's credit card account etc.

According to examples described herein, a user can access the network service 120 to (i) purchase or otherwise acquire an e-book (or other form of digital content item), (ii) transfer right of possession to an e-book, and/or (iii) publish an offer to transfer the right of possession to an e-book (e.g., user can publish book available to be borrowed or purchased from user library). The purchasing of the e-book can correspond to the user acquiring a right of possession to read the e-book. In one example, the purchasing input 111 can specify (or be correlated to) the account identifier 115 and a purchased e-book 117 (e.g., specific e-book that is being purchased). The purchasing interface 132 can record the user's purchasing activity in connection with, for example, a purchased e-book 117. Thus, for example, when the user elects to purchase an e-book 117, the transaction can be recorded in the user account store 124 using the account identifier 115 and an identifier for the purchased e-book 117.

Furthermore, in some embodiments, the network service 120 can act as an intermediary that enables transfer of e-books amongst users. As an intermediary, the network service 120 can manage the right of transfer and other digital management considerations. Additionally, the network service 120 can handle transfer of funds as between users.

According to some embodiments, the computing device 110 can include components for communicating with and utilizing services provided by the network service 120. In example of FIG. 1, the computing device 110 includes a service interface 112, an e-reader component 114, a data store 168 that stores a collection of locally stored e-books 113, and a transfer interface 166. The components of the mobile computing device 110 can be provided by, for example, one or more applications that run on the mobile computing device.

In an embodiment, the service interface 112 operates to programmatically locate the network service 120 over one or more networks (e.g., wireless or cellular network and/or Internet). The service interface 112 also operates to communicate and receive communications (e.g., requests, instructions) and data (e.g., e-books) from the network service 120. Among other functions, the service interface 112 signals the identifier 107 that links the particular mobile computing device 110 to the corresponding user account.

The data store 168 can be implemented with memory resources of the computing device. Downloaded e-books, for example, can be communicated from the service interface 112 to the data store 168. At least some of the e-books 113 include a content portion and a metadata portion for providing a computer-generated visual representation of the e-book. For example, individual e-books 113 can include one or more content files 165 and one or more metadata files 167.

The transfer interface 166 enables the user to (i) select an e-book 159 for transfer, (ii) request specific transaction parameters 161 to publish an offer for an e-book, and/or (ii) request specific transaction parameters 161 to transfer a right of possession to an e-book in the user's collection (e.g., stored with the collection 168) to another user. In some embodiments, the user can provide input to request transaction parameters 161, such as a transaction type, through use of the transfer interface 166. The transaction type can correspond to one of a temporary transfer or a permanent transfer. A temporary transfer can correspond to the user renting or allowing another user to borrow an e-book. The duration of the transfer can coincide with, for example, a pre-determined duration (e.g., 1 week) or with satisfaction of a pre-determined condition (e.g., until transferor requests e-book return or recipient completes e-book). The pre-determined duration or condition can be specified by the user, recipient or set through default.

Still further, as described with some examples, the transfer type can be specified as an exchange. With an exchange, the network service 120 can pair the transfer of rights as between e-books on different user accounts. The transfer of rights involved in the exchange can be either permanent or temporary.

Another transaction parameter 161 that can be specified through the transfer interface 166 includes an amount of the transaction. For example, the user can specify a desired transaction price for an offer, or an actual transaction type (for a transaction that is completed). The transaction price can correspond to a sale price or a rental price.

Still further, another transaction parameter 161 that can be specified through the transfer interface 166 includes a calendar or schedule input. For example, the transfer parameters 161 can specify a date on which an offer for an e-book transfer is valid, or valid through. The transfer parameter 161 can alternatively specify, for example, a duration that an e-book can be borrowed, or is to be borrowed.

In one embodiment, transfer interface 166 signals (via service interface 112) a transfer request 135 to the network service 120. The transfer request 135 can be handled by the transfer manager 134 of the network service 120. The transfer request 135 can be made at one time, or in a series of communications, including a request that makes a preliminary determination as to whether the user can transfer the specified e-book (e.g., user cannot re-transfer e-book acquired from another user if e-book is limited to one transfer per sale; user cannot re-transfer borrowed e-book etc.). Thus, if the user does not have the right to transfer the e-book, the preliminary response 147 from the transfer manager 134 of network service 120 can be to deny the request.

In some implementations, the transfer request 135 can correspond to a request to make an offer available to a user, or group of users. As an addition or alternative, the transfer request 135 can correspond to a request to transfer an e-book 155 for which the user has previously purchased. Accordingly, transfer request 135 can specify the user (or transferor) account 145, and the particular e-book 155 that the user is requesting to transfer. The request can also specify transaction parameters 161, such as the transaction type (e.g., permanent or temporary), the transaction price and/or other conditions of the transfer. Additionally, the request 135 can specify the account or location of the transferee. In some implementations, the transfer manager 134 references the request 135 to the user-account store 124 in order to determine if the user has the right to transfer the specified e-book (e.g., whether the e-book was purchased by the user, and/or whether the user purchased an option for the e-book). Assuming the user has the right to purchase the e-book, the transfer manager 134 implements operations to transfer the e-book.

The transfer manager 134 can implement processes to enable or facilitate the transfer of e-books amongst users in accordance with rules that preclude unauthorized duplication of the e-book amongst different user accounts. The transfer manager 134 can include processes for implementing the transfer of rights to a particular e-book from one user to another, in accordance with rights management policies of, for example, the e-book publisher and/or network service 120. For example, with reference to FIG. 1, many e-books provided through the network service 120 may be provided with a right of possession that is specific to a user or an account. In many cases, for example, the right of possession allows the user to obtain copies on one or more devices that are linked to the user's account. Typically, however, the right of possession conveyed from the network service 120 prohibits or limits the ability of the user to copy or duplicate the e-book on other computing devices that are not linked to the user's account.

The transfer manager 134 implements the transfer of the right of possession in accordance with specific transactions parameter 161 provided through the transfer interface 166 of the mobile computing device 110. The specified transaction parameters 161 can include transaction type, conditional parameters, pricing, calendar information etc. Temporary transactions, for example, can be implemented when one user allows another user to borrow or rent an e-book. Permanent transactions, for example, include transaction types such as re-selling or exchanging e-books.

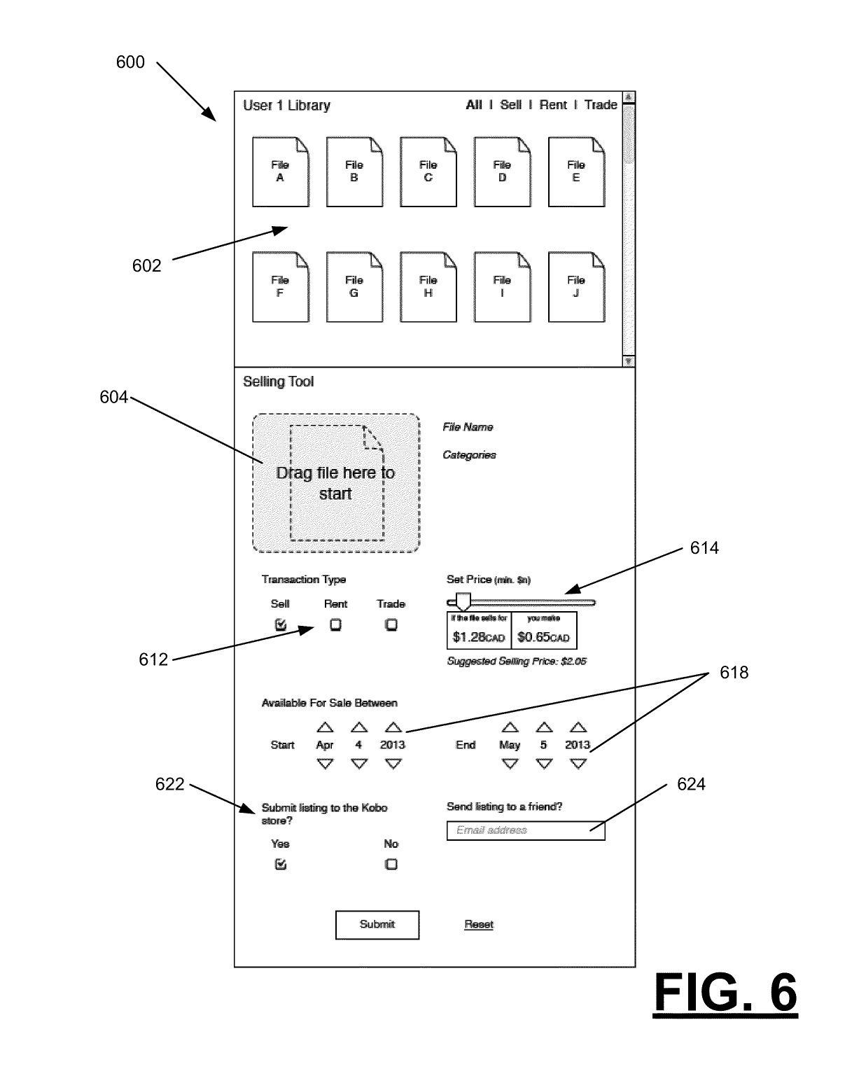

The transfer manager 134 can implement processes to discover the transaction parameters 161 specified by the user. In one implementation, the transfer manager 134 provides an interface such as a web-based form which the user can complete in order to identify the e-book of the transaction, as well as the transaction parameters 161. As another example, in an implementation such as shown by FIG. 6, the transaction manager 134 includes features that enable the user to specify specific transaction parameters 161, such as price and transaction type. Still further, the transfer manager 134 can use programmatic processes to recognize offers and terms from, for example, text input (e.g., user posting).

Some examples described herein recognize that publishers and authors may limit re-transfers of e-books. For example, publishers may restrict when e-books can be resold (e.g., to not conflict with publisher roll out), or the price at which an e-book can be resold. In an example, the transfer manager 134 accesses one or more resources in order to confirm that the transaction parameters 161 requested from the user are permissible. For example, the transfer manager 134 can access a resale parameter store 118 in order to check whether the user's requested transaction parameters 161 are permissible. The resale parameter store 118 can be provided with the e-book store 122. The resale parameter store 118 can include restrictions, specified by, for example, publishers of e-books, on the re-transfer of e-books.

In another example, the transfer manager 134 can control an interface from which the user can specify transaction parameters 161 for re-transferring an e-book. In this way, the interface can predefine the limits of the transaction parameters 161 in advance of the user providing input For example, the interface can provide minimum and/or maximum price limits for which the user can select from as a resale price. The predefined limits can also designate the dates when the transfer can happen (e.g., after a certain date) or limit the transaction type (e.g., preclude second sales or loans).

If permissible transaction parameters are received, the transfer manager 134 can approve an offer of the user in re-transferring a particular e-book. The transfer manager 134 can also publish an offer 149 for the user on a particular forum. The forum can correspond to, for example, an online multi-user forum or messaging forum. The particular forum can be selected by the user making the transfer request.

The transfer manager 134 can operate to monitor the offer and determine when the offer is accepted. For example, in one implementation, the transfer manager 134 embeds a link or other feature that is selected by another user that accepts the offer. Once the offer is accepted, the transfer manager 134 can implement the transaction in accordance with the transaction parameters 161. In some variations, the parties to the transaction can communicate and alter the transaction parameters 161. For example, rather than accepting the offer, the other user can make a counter offer that changes one or more terms of the transaction. The counter offer can then be accepted by the original user in order for the transaction to occur. The communication of the offer 149, or counter-offer can be through the transfer manager 134, which can extract terms of the transaction and implement the transfer accordingly.

In implementing the transfer upon acceptance of the offer 149, the transfer manager 134 signals transfer control 119 to the computing device 110 to delete or lock at least access to a transferred (or to be transferred) content item. For example, the transfer control 119 can lock the content portion 165 of the e-book 113 that is being transferred. The transfer manager 134 can also implement the transfer by disassociating the specified e-book 155 in the transfer request 135 from the transferor user account 125.

For permanent transfers, the transfer manager 134 can trigger the transfer control 119 to (i) delete or lock at least the content portion of a digital content item on one or more devices of the transferor user; and/or (ii) add the digital content item to the account of the recipient of the user (e.g., enable the recipient user to download the e-book at a later time).

For temporary transfers, the transfer manager 134 can implement an initial transfer as between the transferor user and the recipient user, then implement a partial or full reversal of the transfer once one or more conditions of the transfer are satisfied. In one implementation, the transfer manager 134 triggers the transfer control 119 to add or unlock the digital content item on the one or more devices of the transferor user. Additionally, the transfer manager 134 can trigger the transfer control 119 to delete or lock the digital content item on the device(s) associated with the account of the recipient of the user. The conditions for implementing the reverse transaction include, for example, (i) completion of a duration of time specified by the transferor user at the initial transaction (e.g., how long an e-book can be borrowed), (ii) input from one or both of the users, or (iii) detection of an event, such as the recipient user completing the e-book.

For transaction types that correspond to exchanges, the transfer manager 134 can implement two sets of transfers, which can be either permanent or temporary. One set of transfers deletes or locks a first e-book on the device(s) of a first user, then adds or unlocks the first e-book on the device(s) of a second user. Another set of transfers deletes or locks a second e-book on the device(s) of the second user, then adds or unlocks the second e-book on the device(s) of the first user.

The transfer manager 134 can also perform steps to add or associate the subject e-book to the transferee account 157. For example, the transferee may have an existing account with the user account store 124, and the transfer manager 134 may associate data in the user account store 124 to enable the transferee user to download the e-book from the network e-book store 122 (e.g., through the purchasing interface 132). Alternatively, the transfer manager 134 can implement, or communicate with other processes that implement issuance of a coupon or receipt for redemption of the e-book from an online bookstore.

In implementing processes to transfer the right of possession from one user (transferor) to another (recipient), the transfer manager 134 can also implement conditions or criteria of the transfer. Such conditions or criteria can include those that need to be satisfied initially, such as fund transfer or exchange. Additionally, the conditions or criteria include those that may be satisfied after the transfer is implemented, such as the passage of time (for temporary transfers).

Additionally, the transfer manager 134 can perform steps for distributing funds in connection with the transfer. In one embodiment, the transfer request 135 (or follow on communication) specifies funds that are (or are to be) exchanged between the transferor and the transferee. Depending on implementation, the transfer manager 134 can distribute funds using a variety of formulas or distribution algorithms. For example, a designated portion of the proceeds can be distributed to the publisher and/or operator of the network service 120.

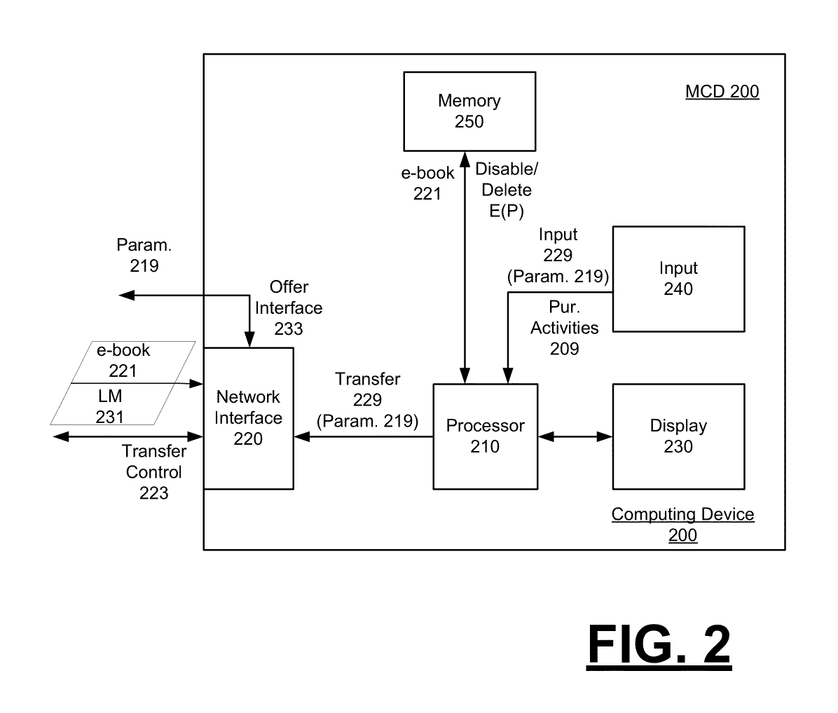

FIG. 2 illustrates an example of a mobile computing device in accordance with examples described herein. A computing device 200 can include a processor 210, a network interface 220, a display 230, one or more input mechanisms 240, and a memory 250. The processor 210 can utilize the network interface 220 to communicate with a network service 120 (see FIG. 1). Accordingly, the computing device 200 provides an example of mobile computing device 110 (as shown with FIG. 1), for use with network service 120. In communicating with the network service 120, the mobile computing device 200 can receive e-books 221 that the user has purchased or otherwise selected to download from the network service.

In some embodiments, the e-books 221 can be provided with a locking mechanism 231 that enables at least the content portion of the content items to be locked from user access. The locking mechanism 231 can be triggered (e.g., from a network) to lock the e-books. For example, the network service 120 may provide transfer control signal 223 to lock the locking mechanism 231 of a given e-book 221.

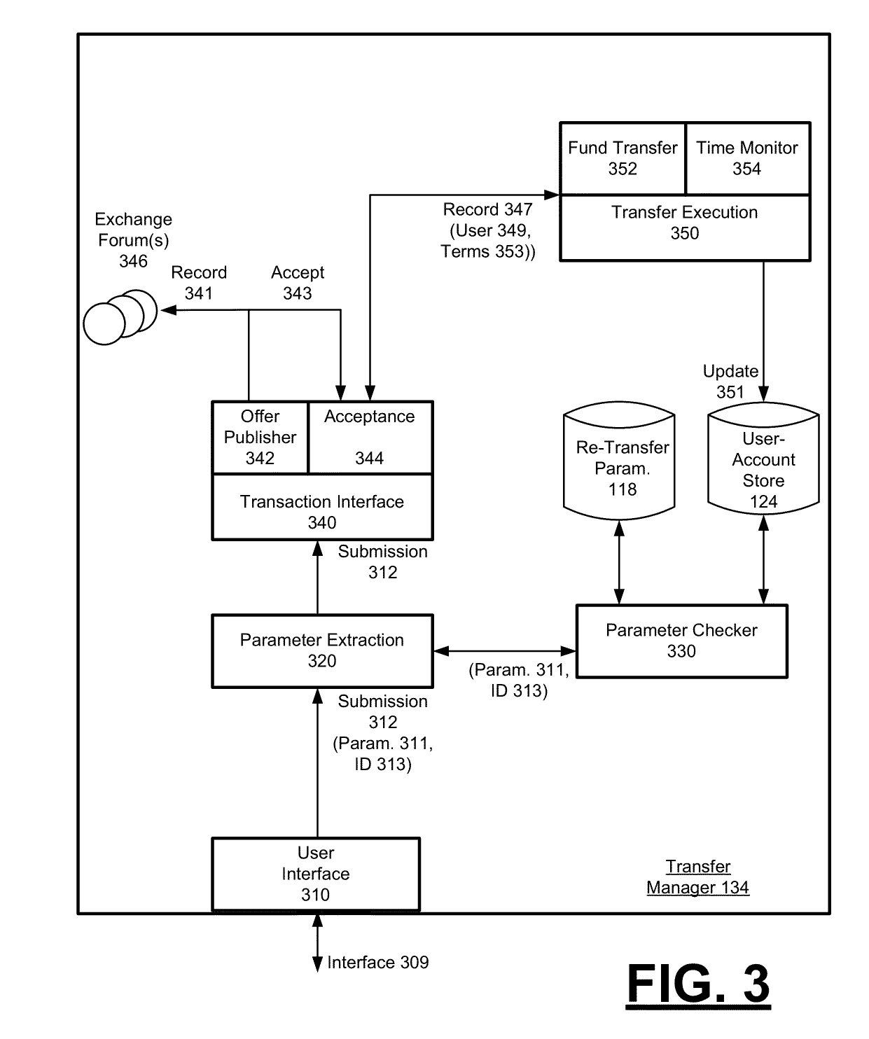

The memory 250 includes instruction memory for storing instructions from which programmatic operations are performed by the processor 210. Among other functionality, the memory 250 can store instructions that enable the processor 210 to implement programs in accordance with an example of FIG. 1 or FIG. 3.

Additionally, the e-books 221 that are downloaded onto the mobile computing device 200 may be stored in the memory 250. The memory 250 can provide a data store that stores records corresponding to individual e-books. The individual records of each e-book can link content files and metadata files.

The processor 210 can execute programs by reading instructions from the memory 250. Additionally, the processor 210 may perform read operations on the memory 250 in order to retrieve stored e-books to 221. The retrieved e-books 221 can be rendered on the display 230.

The display 230 can correspond to, for example, a liquid crystal display (LCD) that illuminates in order to provide content generated from processor 210. In alternative variations, for example, the display 230 can correspond to an electronic paper type display, which can be designed to mimic conventional paper in the manner in which they display content. Examples of such display technologies include electrophoretic displays, electrowetting displays, and electrofluidic displays. Examples described herein further appreciate that the media in which electronic type displays are provided can vary, and include, for example, plastic or paper combined with transistor elements or other circuitry.

In some embodiments, the user may operate the mobile computing device 200 to enter input corresponding to transaction activities 209. The transaction activities 209 can correspond to (i) the user purchasing e-books 221 directly from the network service 120, or (ii) the user generating offers for re-transferring purchased e-books, and/or completing re-transfer transactions. In some variations, the user may user can also transaction for additional rights, such as to acquire (e.g., from the publisher or from the network service 120) the right to loan or re-sale the e-book. For example, the network service may offer the user an option to resell purchased e-books. In one implementation, an application on the computing device 200 enables the user to access an online bookstore. The user may have an account established with the online bookstore. The user may operate the mobile computing device 200 to view and/or purchased e-books for consumption on the device (as well as other devices that may be linked to the same account). For example, the user may be able to purchase an e-book by operating an application on the computing device 200. In response to purchasing an e-book, the e-book 221 may automatically be downloaded to the device 200. As described with examples, each downloaded e-book 221 can include a content portion and a metadata portion. When the user downloads the e-book, the user may also acquire the right to read the content portion of the e-book.

In some embodiments, the user can also enter input 229 to generate an offer for re-transferring a purchased or downloaded e-book. The input 229 can include or otherwise specify one or more transaction parameters 219 for the offer, such as parameters that designate a transaction type (e.g., temporary or permanent), transaction price, schedule or calendar and/or price. In some implementations, the transaction parameters 219 can be requested from the network service 120, which in turn determines whether the transaction parameters are permissible.

In some variations, the computing device 200 receives an offer interface 233 from the network service 120. The offer interface 233 can be in the form of an application interface or web page, and can provide fields and/or functionality (e.g., see FIG. 6) for enabling the user to specify parameters 219 for use in generating an offer to re-transfer an e-book based on the input 229. In one implementation, the network service 120 generates an offer based on the parameters 219 communicated from the computing device 200. As mentioned with an example of FIG. 1, the network service 120 can publish an offer based on the transaction parameters 219. Once the offer is published, it can be accepted, then the transaction parameters 219 can be implemented in connection with implementing the transfer specified in the transaction.

Typically, the downloading of the e-book is specific to a user, user device or user account. Once the e-book is transferred, the computing device 200 can receive transfer control signal 223 from the network service 120. The transfer control signal 223 can cause, for example, any one or more of the following: (i) delete the content portions of the local copy of a specified e-book that was transferred, (ii) disable or programmatically lock the content portions of the contents (e.g., preclude viewing of some or all pages of an e-book) of an e-book that was transferred, or (iii) disable/delete some but not all content (e.g., enable viewing of insert of select pages, first chapter etc.) portions of the transferred e-book. In some embodiments, the locking mechanism 231 provided with the individual e-book can be signaled to lock, so as to preclude user access to the content portion of the corresponding e-book.

FIG. 3 illustrates an example transfer manager operating as part of a network service, according to an embodiment. Reference is made to elements of FIG. 1 for purpose of context and example, in accordance with some embodiments described herein. In an example shown by FIG. 3, the transfer manager 134 includes components that include a user interface 310, parameter extraction 320, parameter checker 330, and transaction interface 340. The user interface 310 can generate an interface 309 that is communicated to the computing device 110 (FIG. 1) for purpose of enabling the user to request parameters for transferring an e-book of their collection. For example, the user interface 310 can provide a web page with fields that the user can complete, or provide an application interface such as shown with an example of FIG. 6. Among other features, the user interface 310 enables the user to (i) specify an e-book from their collection, (ii) specify desired parameter corresponding to price, (iii) specify a parameter corresponding to a type of transfer (temporary, permanent, exchange etc.) and/or (iv) other parameters such as a forum where an offer is to be provided, or other user-defined parameters. The user interface 310 can thus output the interface 309 for a given computing device, and receive the submission 312 from a user that includes requested parameters 311 and an identifier 313 of an e-book within the particular user's collection.

The parameter extraction 320 can operate in connection with the user interface 310 in order to scan or otherwise process the submission 312 made by the user through the user interface 310. For example, in an implementation in which the submission from the user is made through a web page, the parameter extraction 320 can scan the page to identify fields and their respective values. The fields and values can correspond to, for example, transaction type, price, timing parameters relating to when transfer is available or needs to be completed by, and/or user defined parameters.

In some embodiments, the parameters 311 and identifier 313 can be communicated from the parameter extraction 320 to the parameter checker 330. The parameter checker 330 can determine whether the parameters 311 requested from the user are permissible. In one implementation, the parameter checker 330 references one or more parameters 311 to the account store 124 to determine whether the user has the right to transfer the selected e-book. For example, the parameter checker 330 can determine from the account store 124 whether the e-book assigned to the user is a temporary re-transfer that has a transfer restriction, or an e-book that was previously re-transferred and has a transfer-once restriction. Still further, in some variations, the parameter checker 330 can determine from, for example, the account store 124, whether the user acquired an additional right (or option) to transfer the particular e-book.

The parameter checker 330 can also utilize the re-transfer parameter store 118 in order to determine whether the parameters 311 are permissible for the e-book identifier 313. The re-transfer parameter store 118 can store parameters determining permissible (or non-permissible) parameters, as provided by, for example, the publisher of the e-book. For example, the parameter store 118 can define whether the e-book can be transferred more than one time, the price range for how much an e-book can be transferred, the type of exchanges (e.g., temporary or permanent) that are permitted, and/or blackout dates when e-books cannot be transferred.

In one embodiment, the parameter checker 330 determines whether the requested parameters 311 of the user are permissible or not. If permissible, then the parameter checker signals approval, and the submission 313 is forwarded to the transaction interface 340. If one or more requested parameters are not permissible, the user interface 310 can signal the user the denial and/or to change the requested parameter. As an addition or alternative to an example of FIG. 3, the user interface 310 can pre-define permissible parameters upon receiving a user's request to transfer a particular e-book. For example, the user may communicate through the user interface 310 a desire to transfer a particular e-book from the user's library. In response to receiving the request, the parameter extraction 320 and checker 330 combine to predetermine non-permissible parameters, or alternatively permissible parameters and ranges thereof. For example, the publisher of a particular e-book may attach a minimum and maximum price to the resale of a particular e-book, and further preclude temporary exchanges. The user-interface may then reflect in advance of receiving user input, the permissible parameters, so that the user can only specify parameters that are permissible. For example, the impermissible price points and transaction types may be grayed out on a feature menu generated from the interface 310.

Once the transaction interface 340 receives the submission 312 with permissible parameters, the transaction interface can publish an offer corresponding to the submission 312. In one implementation, an offer publishing component 342 generates a record 341 that corresponds to an offer. The record 341 is then posted to a forum 346, such as an online book exchange, message board or social networking page of the user. Alternatively, the record 341 can be communicated back to the user for transmission to another person via, for example, a messaging transport. Still further, the user can be provided a link to the record and can post the record to, for example, a social networking page. The record 341 can include active elements that trigger a signal to the transaction manager 340 when the offer is accepted. For example, the record can include an acceptance button that can be selected by a recipient or viewer of the record in order to communicate an acceptance of the offer. Alternatively, the record 341 can include features that enable the viewer or recipient to counter offer, in which case a notification is generated in connection with the record 341 for the user to accept or reject.

The transaction interface 340 can include an acceptance component 344 that processes an acceptance signal 343 received from, for example, the forum 346. The acceptance component 344 can generate a record 347 of the transaction, including the identifiers 349 of the users, and the terms 353 of the transaction (e.g., price, timing, type etc.).

According to some embodiments, the transfer manager 134 can include a transfer execution component 350 which then implements the terms of the transfer from the network service 120. On the network, the transfer execution component 350 updates 351 the user account store 124 to de-associate a transferred e-book from the transferor's account, while simultaneously associating the transferred e-book to the transferee account. The transfer execution component 350 can also cause the performance of additional steps to (i) lock or delete the identified e-book on the transferor device or devices, and (ii) unlock or enable download of the identified e-book on the transferee device or devices.

In some embodiments, transfer execution component 350 operates processes to manage transfer of funds. The transferee who purchases an e-book can be charged (e.g., account automatically debited). The fund transfer component 352 can operate to transfer a portion of the funds from the account of the transferee to the account of the transferor. In some variations, the fund transfer component 352 can also transfer a portion of the proceeds to the operator of the network service 120 and/or to the publisher of the e-book.

Still further, some embodiments provide for the transfer execution component 350 to include a time monitor 354 for monitoring temporary transfers. A temporary transaction can, for example, be specified for a set duration of time, such as week. The time monitor 354 tracks, for a given transaction, the duration of time in which the transfer is in effect. Upon completion of the duration, the time monitor 354 signals the transfer execution 350 to reverse the transaction. In response, the transfer execution component 350 updates 351 the user account store 124 to re-associate a previously transferred e-book to the transferor's account, while simultaneously de-associating the previously transferred e-book from the transferee account. The transfer execution component 350 can also cause the performance of additional steps to (i) lock or delete the identified e-book on the transferee device or devices, and (ii) unlock or enable download of the identified e-book on the transferor device or devices.

As an addition or alternative, the time monitor 354 of the transfer execution component 350 can base temporary transfers on completion of events, such as upon the transferee completing reading the transferred e-book. The time monitor 354 can, for example, track the transferee in their progression through the transferred e-book and signal the exchange upon the event (transferee completing the e-book) being satisfied.

Methodology

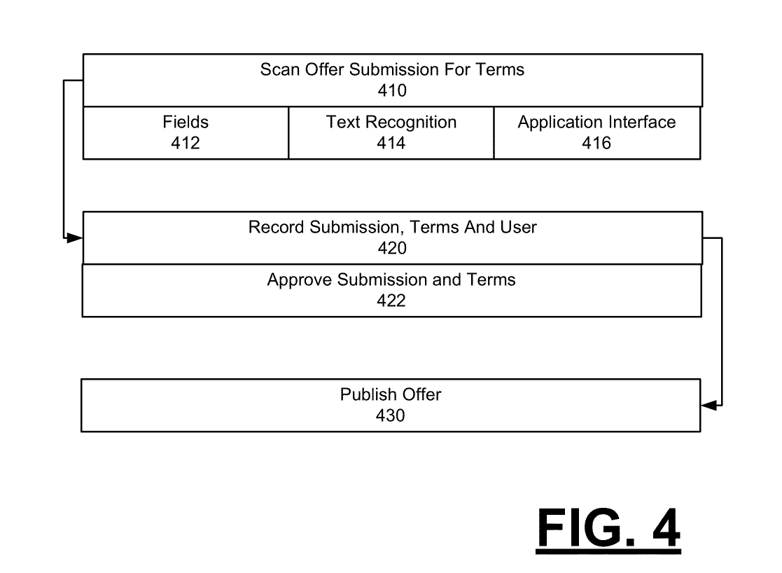

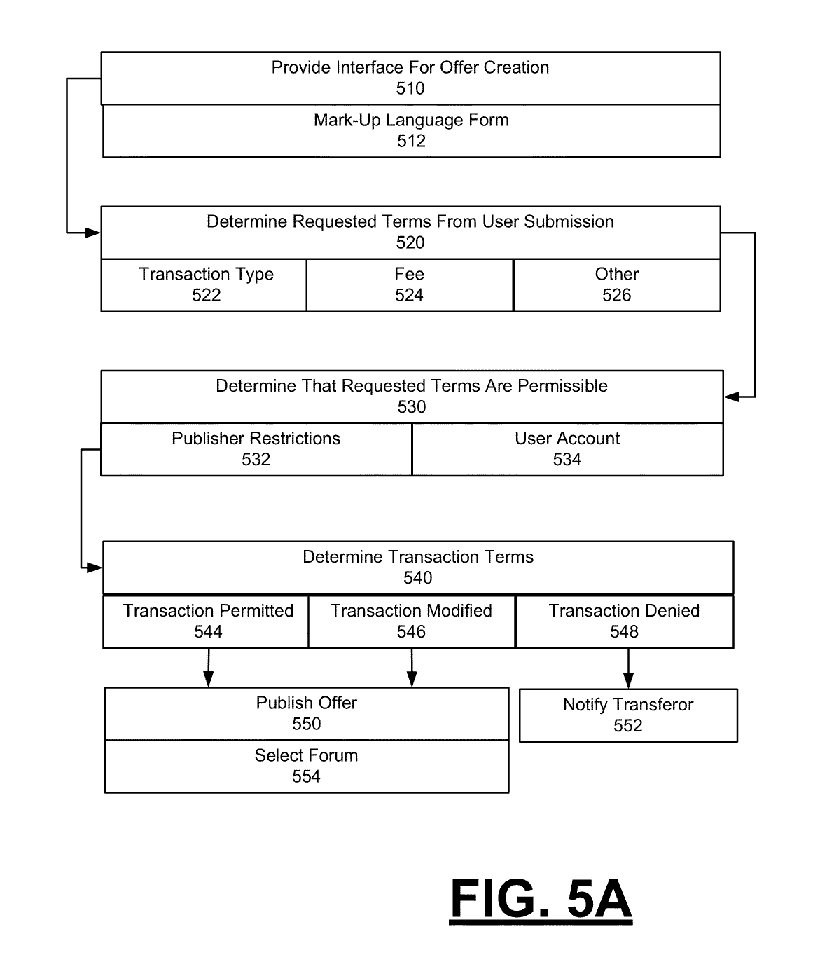

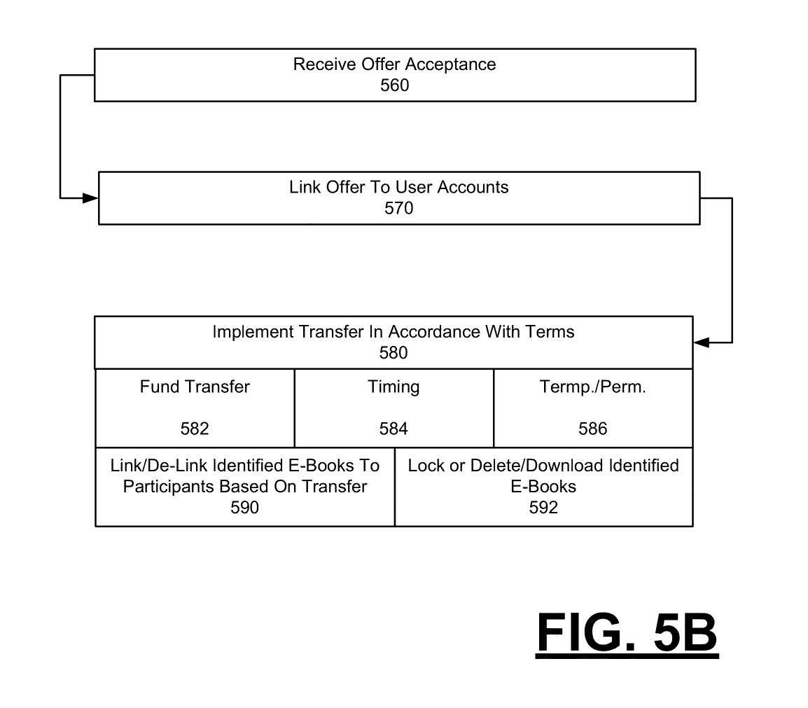

FIG. 4 illustrates an example method for processing a submission from a user wishing to publish an offer for transferring an e-book from the user's library, according to an embodiment. FIG. 5A illustrates an example method for publishing an offer based on a user submission, according to an embodiment. FIG. 5B illustrates an example method for implementing terms of an offer upon the offer being accepted, according to an embodiment. Examples such as described by FIG. 4, FIG. 5A or FIG. 5B may be implemented using components such as described with FIG. 1, FIG. 2, or FIG. 3. Accordingly, reference may be made to elements of other figures for purpose of illustrating suitable elements or components for performing a step or sub-step being described.

With reference to FIG. 4, a user provide a submission to a network service 120 with one or more requested terms of transfer. The submission may be scanned or analyzed in order to determine parameters corresponding to the requested terms. For example, the transfer manager 134 can identify fields in a form, and use the values in order to determine the requested parameters (e.g., requested transfer price, requested transaction type etc.) (412). Alternatively, text recognition can be used (414). For example, a free-form submission (e.g., email) can be submitted to the network service 120, and the transaction manager 134 can use text recognition to determine some or all of the requested parameters. Still further, in some variations, an application interface can be manipulated in order to generate values corresponding to the requested parameters of the user (416)(see e.g., FIG. 6).

The requested terms and specifics of the submission are recorded (420). Optionally, the terms can be approved by components of the network service.

The offer can then be published on behalf of the user through the network service (430). For example, the offer can be published as part of an online book exchange. Alternatively, a record of the offer can be communicated to the user, and the user can publish the record (or a link to the record) in an email or posting etc. In some implementations, the record can include links or other active elements that monitor the acceptance of the offer when published in forums that are outside of the domain of the network service.

With reference to FIG. 5A, network service 120 operates to provide a user an interface for enabling the user to create an offer (510). Various types of interfaces can be provided, such as an application interface in which features (value bars, check boxes) can be selected or manipulated to specify parameters corresponding to terms of an offer. Still further, another implementation can provide for use of a markup-language form (e.g., web page) which the user can complete (512). In another variation, no structured form is needed, rather the user can provide a free form submission that includes specific terminology or keywords (e.g., price, title of e-book etc.).

The network service 120 (e.g., transfer manager 134) can determine the requested terms from the user submission (520). For example, a markup-language form can be scanned for fields and values. Alternatively, the input from an application interface can be received and processed as, for example, an input stream which correlates values to specific parameters. In an implementation in which free form submissions are enabled, the network service 120 can provide for text recognition in order to detect key words and values corresponding to the requested parameters.

In some embodiments, the requested terms can correspond to one or more of the following: (i) transaction type (e.g., temporary versus permanent or exchange, gift etc.) (522); (ii) a fee amount for transfer (524), and/or (iii) other parameters (526) such as timing of offer (when offer is valid through) or user-defined restrictions.

Upon determining the requested terms, some embodiments provide that the network service 120 checks to see whether the requested terms are permissible (530). In one implementation, the transfer manager 134 checks at least some of the requested terms against publisher's restrictions (532). For example, the network service 120 can maintain the data store 118 of publisher re-transfer restrictions, which identify permissible (and non-permissible) restrictions on the re-transfer of e-books. Examples of publisher restrictions include (i) limiting the number of times an e-book can be re-transferred after it is downloaded, (ii) restricting minimum and/or maximum amounts that can be charged for a re-transfer, (iii) restricting when an e-book can be transferred (e.g., number of days after release etc.), (iv) requiring the transferor to separately purchase a right to re-transfer, and (v) requiring certain user actions, such as another purchase.

The network service 120 (e.g., transfer manager 134) can also check the user account store 124 to ensure the user has the right to transfer an e-book (534). The user account store 124 can, for example, identify whether the user has permanent or temporary right of possession, when the publisher permits only permanent right of possession holders to transfer the e-book. As another example, the user account store 124 can identify whether the user has acquired the right to purchase the e-book. More general determination can also be performed, including determining whether the user account is in good standing, or whether the user has proper (e.g., legal) right of possession to the e-book.

Once the requested terms are checked, an embodiment provides that the transaction terms of the user's offer are determined (540). If the requested terms are permissible, then the transaction terms may be the same as the requested terms, and the transaction is permitted (544). In some variations, if any of the requested terms are not permitted, then some or all of the impermissible terms are programmatically modified to be permissible (546). For example, the transaction manager 134 can check the re-transfer parameter store 118 to determine if the user specifies a minimum price that is below that which is permitted from the publisher, and if the user's price is too low, then the transaction manager 134 can automatically raise the price.

The permitted transaction can be published as an offer (550). In some variations, the forum where the offer is published can be selected by the user (554). For example, the user can select one or more online book exchanges, and the service 120 publishes a record corresponding to the offer at the exchanges. Still further, the transferor can select to message the offer to a recipient, or to post the offer in an alternative electronic forum, in which case the transferor receives a link or other rendition of the offer. The transferor can then self-publish the link or communicate it to another person via a message.

Still further, if any of the requested terms are impermissible, then the transaction can be denied (548). If the transaction is denied, then the transferor can be notified (552).

With reference to FIG. 5B, the network service 120 can detect when the offer is accepted by a user (560). In one implementation, a record of the offer can include active components such as a link which is selected by a recipient or viewer of the record when the offer is to be accepted. The link can signal acceptance of the offer to the network service 120. In a variation, the network service 120 can host the forum where the offer is published, and the acceptance can be detected by the recipient/viewer interaction with the forum.

With acceptance, the record can be linked to the pertinent accounts of the participants (570). Specifically, the offer can be linked to the account of the transferor-user and the transferee-user. Additionally, the specific e-book(s) that are the subject of the transfer can be marked for each account.

The network service 120 can implement the transfer in accordance with the terms of the offer (580). In implementing the transfer, the network service 120 can trigger or control the transfer of funds (582). For example, the transfer manager 134 can transfer funds in accordance with the price listed in the offer from the account of the transferee to the account of the transferor.

In some implementations, the offer can include timing parameters (584). For example, the offer can specify the transaction can be reversed within an hour (or some other time), or that the transfer is to occur on a designated day. The transfer manager 134 can implement the transfer terms in accordance with the designated timing parameter.

Still further, the transfer can be implemented in accordance with whether the transfer is permanent or temporary (586). If permanent, the transfer is not reversed. If temporary, the transfer is reversed after the passage of time.

In implementing the transfer, the transfer manager 134 can communicate with the user accounts 124 to (i) de-link the transferred e-book from the transferor-user account, and (ii) link the transferred e-book to the transferee-user account (590). Additionally, the transfer manager 134 can operate to cause the identified e-book to be (i) locked or deleted on the transferor-user's device (or devices), and (ii) unlocked or downloaded onto the transferee-user's devices.

If the transaction is temporary, the transfer can be reversed after passage of a designated duration of time or the occurrence of an event (e.g., transferee completes the e-book). The basis for reversing the transfer can be specified as a term of the offer. When the transfer is reversed, transfer manager 134 can operate to cause the identified e-book to be (i) unlocked or added onto the transferor-user's device (or devices), and (ii) locked or deleted on the transferee-user's devices.

Transaction Interface

FIG. 6 illustrates an example of a transaction interface for enabling a user to specify transaction parameters for generating an offer to transfer an e-book to another user, according to an embodiment. An example interface such as shown with FIG. 6 can be provided by the network service 120 through, for example, the user interface 310 (see FIG. 3) of the transfer manager 134.

In an embodiment, a transaction interface 600 includes a library interface 602 and a selection mechanism 604. The library interface 602 can display visual representations (e.g., through metadata files associated with individual e-books) of e-books in the user collection. In examples described herein, one or more (but not necessarily all) of the e-books can be associated with an ability for user to transfer the corresponding right of possession to another user. The selection mechanism 604 can enable the user to select the e-book for transfer through, for example, a click and drag operation or file selection interface.

In selecting the e-book, the user can specify a set of transaction parameters for implementing the transaction. In particular, a set of transaction type options 612 can enable the user to select the type of transaction, such as sell, rent (as an example of temporary transaction) or trade. A price feature 614 enables the user to specify the desired price or price range for an e-book that the user is seeking to transfer. The parameters specified by the user can be subject to approval by the network service 120. Alternatively, the parameters can be communicated to the user through the interface 600 in a manner that precludes the user from selecting parameters that are not permissible. For example, the transfer manager 134 can configure the interface 600 to reflect values for a specific e-book, based on, for example, re-transfer parameters associated with the particular e-book.

As an addition or alternative, the user can also specify one or more scheduling parameters 618. For example, the scheduling parameters 618 include a date range for a transaction offer, corresponding to when an e-book is made available for other users who wish to purchase the e-book.

Additionally, the user can specify transaction parameters 622 corresponding to a forum or medium for where the transaction offer is made available. Alternatively, a feature 624 can enable the user can specify a particular individual (e.g., by email address) to receive the transaction offer.

The user can submit the transaction offer. If accepted, the transaction can be implemented in accordance with the transaction parameters specified by the user. For example, a transaction can be implemented as an exchange, or as a rental, depending on selections made by the user. When implemented, a process such as described with, for example, FIG. 4 or FIG. 5 may be implemented in order to execute the transaction in accordance with user-specified parameters.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computer system comprising:
a memory that stores a set of instructions;
one or more processors that are coupled to the memory to perform operations that include:
provide an interface for a user to specify input corresponding to a set of requested terms for soliciting a transfer of a particular digital content item;
determine, from the input, the set of requested terms;
determine that the user has a right to transfer the particular digital content item; and
publish an offer for the user that includes the set of requested terms.

2. The system of claim 1, wherein the one or more processors:
identify a set of rules that define permissible terms for the particular digital content item;
determine if the set of requested terms is permissible based on the set of rules associated with the particular digital content item;
if the set of terms are permissible, publish the offer.

3. The system of claim 1, wherein the set of requested terms include a price or price range for transferring the digital content item from the user to another user.

4. The system of claim 1, wherein the set of requested terms include a transaction type, the transaction type including at least one of a temporary transfer or a permanent transfer.

5. The system of claim 1, wherein the set of requested terms includes a term that identifies a forum for where an offer based on the set of requested terms is to publish.

6. The system of claim 5, wherein the one or more processors control publishing the offer that includes at least some of the set of requested terms.

7. The system of claim 1, wherein the one or more processors determine that the user has the right to transfer the particular digital content item by determining that the user purchased a right to transfer the particular digital content item.

8. The system of claim 1, wherein the interface corresponds to a web-based form.

9. The system of claim 1, wherein the one or more processors modify one or more terms in the set of requested terms which are not otherwise permissible.

10. The computing device of claim 1, wherein the selected digital content item corresponds to one of an e-book, electronic magazine or electronic comic book.

11. The computing device of claim 1, wherein the selected digital content item includes at least one of an audio playback content item, a video playback content item or a multimedia game.

12. The computing device of claim 1, wherein the one or more processors publish the offer by generating a link that can be communicated by the user through a selected electronic medium.

13. A computer-readable medium that stores a set of instructions, the set of instructions being executable by one or more processors to perform operations that include:
providing an interface for a user to specify input corresponding to a set of requested terms for soliciting a transfer of a particular digital content item;
determining, from the input, the set of requested terms;
determining that the user has a right to transfer the particular digital content item; and
publishing an offer for the user that includes the set of requested terms.

14. The computer-readable medium of claim 13, further comprising instructions for:
identifying a set of rules that define permissible terms for the particular digital content item;
determining if the set of requested terms is permissible based on the set of rules associated with the particular digital content item;
if the set of terms are permissible, publish the offer.

15. The computer-readable medium of claim 13, wherein the set of requested terms include a price or price range for transferring the digital content item from the user to another user.

16. The computer-readable medium of claim 13, wherein the set of requested terms include a transaction type, the transaction type including at least one of a temporary transfer or a permanent transfer.

17. The computer-readable medium of claim 13, wherein the set of requested terms includes a term that identifies a forum for where an offer based on the set of requested terms is to publish.

18. The computer-readable medium of claim 17, further comprising instructions for controlling publishing of the offer that includes at least some of the set of requested terms.

19. The computer-readable medium of claim 13, wherein instructions for publishing the offer include instructions for generating a link that can be communicated by the user through a selected electronic medium.

20. A computer-implemented method for enabling transactions for right of possession to digital content items, the method being implemented by one or more processors and comprising:
providing a user an interface to specify input corresponding to a set of requested terms for soliciting a transfer of a particular digital content item;
determining, from the input, the set of requested terms;
determining that the user has a right to transfer the particular digital content item; and
publishing an offer for the user that includes the set of requested terms.
